(19) United States
(12) Patent Application Publication
(10) Pub. No.: US 2006/0027024 A1
(43) Pub. Date: Feb. 9, 2006

(54) Check meter for hydraulic crimping tools

(75) Inventor: Takayuki Fujimori, Tokyo (JP)

Correspondence Address: LINIAK, BERENATO & WHITE, Suite 240, 6550 Rock Spring Drive, Bethesda, MD, 20817, US

(73) Assignee: IZUMI PRODUCTS COMPANY

(21) Appl. No.: 10/950,636

(22) Filed: Sep. 28, 2004

(30) Foreign Application Priority Data
Aug. 3, 2004 (JP) 2004-227272

(51) Int. Cl. G01L 7/00

(52) U.S. Cl. 73/700

(57) ABSTRACT

Disclosed is a check meter capable of directly measuring a biting force of a hydraulic crimping tool in which a plurality of dice equally and simultaneously presses together a work piece, such as a sleeve, inwardly in four directions when the hydraulic crimping tool is in the usable state. The check meter includes a biting pressure and a pressure meter. Here, the biting pressure sensor is bitten by at least two dice facing each other, and creates a liquid pressure in proportion to a biting pressure imparted by the two dice. Further, the pressure meter measures the liquid pressure created by the biting pressure sensor.

### BACKGROUND OF THE INVENTION

1. Field of the Invention

An apparatus consistent with the present invention relates to a check meter for measuring a biting pressure of a hydraulic crimping tool by which a connector and a sleeve for electrical wires are crimped. Specifically, the apparatus relates to a check meter most suitable for a hydraulic crimping tool which presses a work piece inwardly in four directions equally and simultaneously.

2. Description of the Related Art

In electrical work such as routing of electrical wires, hydraulic crimping tools have often been used. Typically, a hydraulic crimping tool has four angler (or inverted “V” shaped) dice, which equally and simultaneously presses a work piece together, such as a hollow sleeve, inwardly in four directions. However, there has not yet been any measuring equipment capable of directly measuring a biting pressure of such a hydraulic crimping tool by putting its sensor between the pressing surfaces of the tool. Therefore, to begin with, the liquid pressure of the hydraulic crimping tool is measured with a pressure meter. Following this, the measured value and a working area of a piston in the hydraulic crimping tool are multiplied together. Finally, the biting pressure is determined based on the multiplied value. In this way, the biting pressure is measured indirectly.

FIG. 5 is a partially longitudinal sectional view of a hydraulic crimping tool equipped with a connecting aperture, which is used to connect with a pressure meter for measuring a liquid pressure in the tool itself. In this hydraulic crimping tool, the biting pressure is determined based on the liquid pressure that is measured with a pressure meter. A hydraulic crimping tool 300 is provided with a crimp head 50 which includes a substantially Y-shaped fixed head 51 and a guide plate 52 on the inner side of the fixed head 51. Further, the crimp head 50 includes sliders 53 and 54 which slide along the edges of the guide plate 52.

The crimp head 50 is attached to a main body 30, and can be turned therearound within a predetermined range. The main body 30 has a base end 31 to which a fixed handle 33 receiving an oil tank 32 is attached. The main body 30 has an upper portion into which a plunger 34 is inserted. Above this plunger 34, a pressurized handle 40 is supported by a pivotal axis 38 being placed on the upper frame 37a, and a pivotal axis 41 of the pressurized handle 40 is accommodated inside a recess above the plunger 34. These components make up a pump mechanism operating in such a way that the upward and downward movements of the pressurized handle 40 allows the plunger 34 to move vertically.

A base 51a of the fixed head 51 is attached to the main body 30, and can be turned therearound within a predetermined range. A die 71 is fixed to a tip 51b of the fixed head 51. The guide plate 52 is coupled to a piston 55 of the main body 30. When the pressurized handle 40 attached to the main body 30 is moved upwardly and downwardly several times, operating oil flows to a cylinder 56, and a piston 55 in the cylinder 56 is then moved, thereby pushing out the guide plate 52 toward the tip 51b.

At the center of the crimp head 50, a sleeve 46, that is, a work piece to be machined into which an electrical wire 47 is inserted is set. This sleeve 46 is then pressed by four dice 71, 72, 73 and 74 in relation to the movement of the piston 55. As a result, the electrical connection between the pressed sleeve 46 and the electrical wire 47 is established.

Next, a movement of the crimp head 50 will be described below. In the hydraulic crimping tool 300 of FIG. 5, when the fixed handle 33 is supported by one hand, and the pressurized handle 40 is moved upwardly and downwardly several times by the other hand, the operational oil in the oil tank 32 flows to the cylinder 56 through hydraulic circuitry, thus pushing out the piston 55. Then, the guide plate 52 coupled to the end of the piston 55 is moved toward the center of the fixed head 51 while being guided by the fixed head 51. In conjunction with the guide plate 52, the dice 73 and 74 are also moved toward the center of the fixed head 51. Subsequently, end surfaces 53b and 54b of the slider 53 and 54 are abutted on rollers 65 and 66 of the fixed head 51, respectively, and the dice 73 and 74 are thereby moved toward the center of the fixed head 51. Consequently, the sleeve 46 is pressed.

As the sleeve 46 is pressed down, the liquid pressure in the cylinder 56 in which the piston 55 pressing the guide plate 52 is incorporated is increased. Additionally, the liquid pressure in a hydraulic circuit being in communication with the cylinder 56 is also increased, and when this liquid pressure reaches a predetermined value, a release valve 23 is opened so that the pressure in the cylinder 56 is maintained to be the predetermined value. Then, the pressurized handle 40 is turned in the direction shown by a a arrow, so that a projection 25 which is not normally abutted on a release pin 24 is made to abut thereon. Subsequently, the pressurized handle 40 is moved to press the release pin 24, so that the hydraulic circuit at high pressure that communicates with the cylinder 56 is made to connect with another hydraulic circuit at low pressure that communicates with the oil tank 32. As a result, the pressure in the hydraulic circuit being communication with the cylinder 56 is relieved. Then, the pressurized handle 40 is turned back in the direction shown by a P arrow by means of an urging force of a spring 26. The abutting of projection 25 on the release pin 24 is also released. In other words, the hydraulic crimping tool 300 returns to its initial usable state.

In such a manner, after the liquid pressure in the cylinder 56 is decreased, the piston 55 in the cylinder 56 is made to return to the initial position by the spring 57, and the guide plate 52 coupled to the piston 55 is thereby also made to return to the initial position. Likewise, the abutting of the sliders 53 and 54 on the roller 65 and 66 is released, so that the sliders 53 and 54 are made to return to the initial positions by means of an urging force generated by springs 67 and 68, respectively. Thereafter, the above-described operation is repeated, thereby ensuring that the sleeve 46 is pressed (refer to Japanese Patent Publication No. 3177828 (paragraph No. 0007, FIG. 1), and Utility Model Application Publication 61-97740 (FIG. 1)).

FIG. 6 is an enlarged longitudinal sectional view depicting a connecting aperture on the main body of the hydraulic crimping tool 300 of FIG. 5. As shown in FIGS. 5 and 6, the connecting aperture 80 is provided with a high pressure joint 81 into which the pressure sensing portion 111 is screwed, and allows the hydraulic circuit in the hydraulic crimping tool 300 to communicate with a pressure sensing portion 111 of a pressure meter 110. With this pressure meter 110, the hydraulic crimping tool 300 can serve as a check meter for measuring the biting pressure of the tool 300 itself. Specifically, in this hydraulic crimping tool 300, the biting pressure is not measured by putting a biting sensor, etc. between the dice, but can be determined in terms of the area of the piston 55. In this regard, a following equation is given:
F=P×S
where F represents a biting pressure, P represents a liquid pressure, and S represents an area of a piston.

FIGS. 7A and 7B are views showing how to measure a biting pressure of another hydraulic crimping tool in combination with a check meter and a measuring jig. Specifically, FIG. 7A is a partially longitudinal sectional view of the hydraulic crimping tool; and FIG. 7B is a partially side sectional view thereof. A hydraulic crimping tool 200 shown in FIG. 7 does not need any connecting aperture as shown in FIGS. 5 and 6, but in turn, needs a conventional check meter 120 equipped with a biting pressure sensor 121 and a pressure meter 110 connected thereto. In this hydraulic crimping tool 200, the biting pressure sensor 121 is inserted into a dummy head 59 of a measuring jig 130, and this check meter 120 measures a force which is generated by the piston 55 and which presses a spacer 39.

The measuring jig 130 is used only when the biting pressure is measured. In this case, the crimp head 50 (see FIG. 5) is once detached from the hydraulic crimping tool 200, and instead, the measuring jig 130 is attached thereto. This crimp head 50 has the four angular dice 71 to 74 which press the sleeve 46 together inwardly in the four directions, whereas the measuring jig 130 has, in order to prevent the damage of the biting sensor 121, two flat dice between which the biting sensor 121 is caught and which press the sleeve 46 together inwardly in the two directions.

FIGS. 8A and 8B are views depicting a conventional check meter. Specifically, FIG. 8A is a partially longitudinal sectional view of the check meter; and FIG. 8B is a partially side sectional view thereof. This check meter is set so as to undergo the biting pressures in the directions shown by arrows X.

A check meter 120 shown in this figure can be used only with tools having flat surfaces between a piston and a head, which can sandwich a biting sensor of the check meter.

However, for a hydraulic crimping tool which presses a work piece, such as a sleeve, inwardly in four directions equally and simultaneously, such conventional check meters have not been able to directly measure the biting pressure in the course of using the crimping tool. This is because, if a check meter measures the biting pressure imparted in four directions, then these bite forces are distributed on the biting pressure sensor, causing an error in a measuring value. Therefore, two aligned forces have been conventionally measured. However, in this case, a measuring jig that converts pressures imparted in four directions into pressures imparted in two directions is necessary. This measuring jig must be exchanged for a crimp head before and after the measurement. This causes an increase in man-hours, and inconveniences.

Instead of the above measurement, the biting pressure can be determined in terms of a value obtained by multiplying together a pressure of the hydraulic crimping tool measured with a pressure sensor and an area of a piston. In this case, however, the hydraulic crimping tool needs to have a connecting aperture provided on the main body of the tool itself in order to measure the liquid pressure with a pressure meter. When the pressure meter 110 for measuring the biting pressure of the hydraulic crimping tool is attached/detached to/from the hydraulic crimping tool through the connecting aperture, attention must be paid such that air, etc. do not enter the hydraulic circuitry in the hydraulic crimping tool through the connecting aperture. Naturally, the attachment/detachment of the pressure meter involves an increase in man-hours and inconveniences.

### SUMMARY OF THE INVENTION

In consideration of the above disadvantages, the present invention has been made. An object of the present invention is to provide a check meter which is able to easily and accurately measure a biting pressure of a hydraulic crimping tool. Concretely, this check meter has a structure that a biting pressure sensor is to be caught between dice of the hydraulic pressure meter, and that any measuring jig is not required. Moreover, the check meter has a structure that a pressure meter does not need to be attached/detached to/from hydraulic circuitry of the hydraulic crimping tool to thereby eliminate possibility that air, etc. enter the hydraulic crimping tool.

According to an aspect of the present invention, there is provided a check meter for measuring a biting pressure of a hydraulic crimping tool, the hydraulic crimping tool having a plurality of angular dice which inwardly press a work piece together, the check meter including:
(a) a biting pressure sensor being bitten by at least two opposed dice out of the dice, the biting pressure sensor for creating a liquid pressure in proportion to a biting pressure exerted by the two dice; and
(b) a pressure meter capable of measuring the liquid pressure created by the biting pressure sensor.

With this check meter, the biting pressure of the hydraulic crimping tool can be measured without connecting the pressure meter of the check meter to the hydraulic circuitry of the hydraulic crimping tool. This makes it possible to become unnecessary of a means by which the pressure meter can be connected to the check meter, and to eliminate the disadvantage of this connection. In addition, this also can eliminate a possibility that air, etc. enter the hydraulic circuitry, and realize a simple, exact measurement of the biting pressure of the hydraulic crimping tool.

According to another aspect of the present invention, the biting pressure sensor of the check meter includes a cylinder and a piston that is fitted into the cylinder and that is moved into the cylinder by means of the biting pressure. Further, each of the cylinder and the piston has a surface being provided with a recess capable of having surface-contact with corresponding one of the two dice or a groove capable of having line-contact with corresponding one of the two dice.

With these recesses or grooves, the cylinder and the piston can receive the biting force of the dice without their deformation, whereby the check meter can achieve a long life time as measuring equipment.

According to still another aspect of the present invention, the biting pressure sensor of the check meter has a width of at most 26 mm perpendicular to a direction in which the biting pressure exerts the biting pressure sensor.

With this the wide of this length, the biting pressure sensor becomes adapted for the minimum opening length of the standard specifications in hydraulic crimping tools. Accordingly, the biting pressure is measured on the condition that only the two dice bite the biting pressure sensor together, and that the other dice are not abutted on the flat surfaces of the biting pressure sensor. This results in prevention of distribution of the biting forces, and achieves the accurate measurement thereof.

### BRIEF DESCRIPTION OF THE DRAWINGS

For a more complete understanding of the present invention and the advantages hereof, reference is now made to the following description taken in conjunction with the accompanying drawings wherein:

FIG. 1A is a partially sectional front view of a check meter according to an embodiment of the present invention;

FIG. 1B is a partially sectional side view of the check meter;

FIG. 2 an enlarged plane view of a crimp head in which dice bite a biting pressure sensor together;

FIG. 3A is a side view of a cylinder of the check meter;

FIG. 3B is a sectional view taken along line A-A of FIG. 3A;

FIG. 3C is a bottom view of the cylinder;

FIG. 3D is a front view thereof;

FIG. 3E is a rear view thereof;

FIG. 4A is a bottom view of a piston of the check meter;

FIG. 4B is a front view thereof;

FIG. 5 is a partially longitudinal sectional view of a hydraulic crimping tool provided with a connecting aperture, which is used to connect with a pressure meter for measuring a liquid pressure in the tool itself;

FIG. 6 is an enlarged longitudinal and sectional view of the connecting aperture of FIG. 5;

FIG. 7A is a partially longitudinal sectional view of the hydraulic crimping tool with a conventional check meter and a measuring jig;

FIG. 7B is a partially sectional side view thereof;

FIG. 8A is a partially longitudinal sectional view of the conventional check meter; and

FIG. 8B is a partially sectional side view thereof.

### DETAILED DESCRIPTION OF THE EXEMPLARY EMBODIMENTS OF THE INVENTION

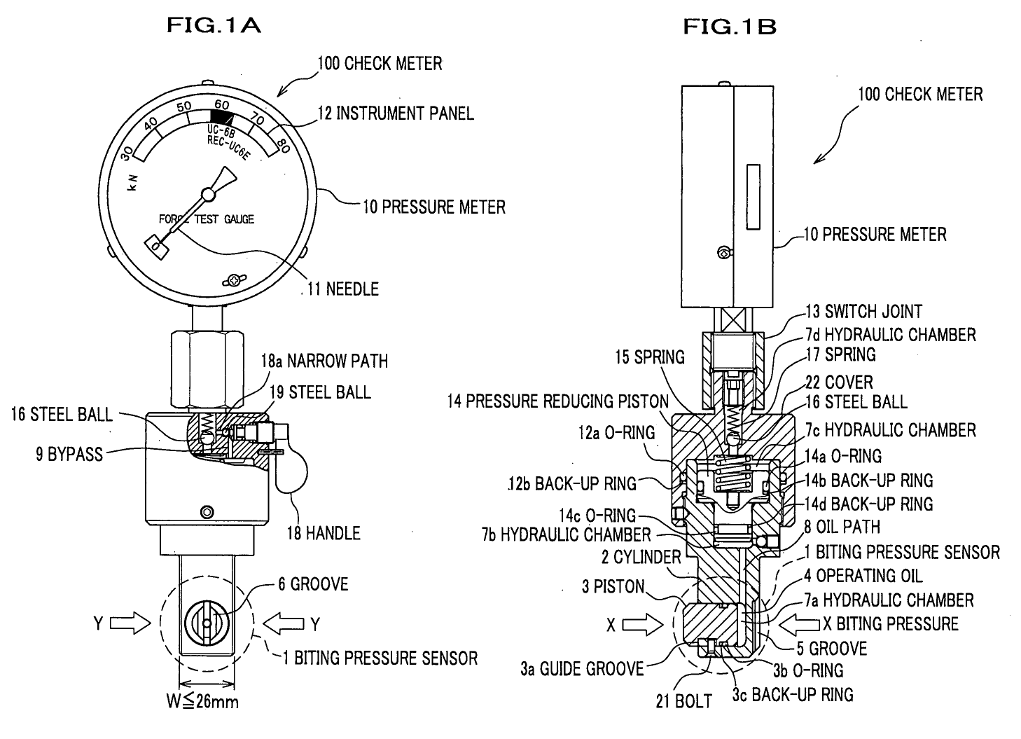

An embodiment of the present invention will be described below with reference to the figures. FIGS. 1A and 1B are partially sectional views of a check meter according to the embodiment of the present invention. Specifically, FIG. 1A is a front view thereof; and FIG. 1B is a side view thereof.

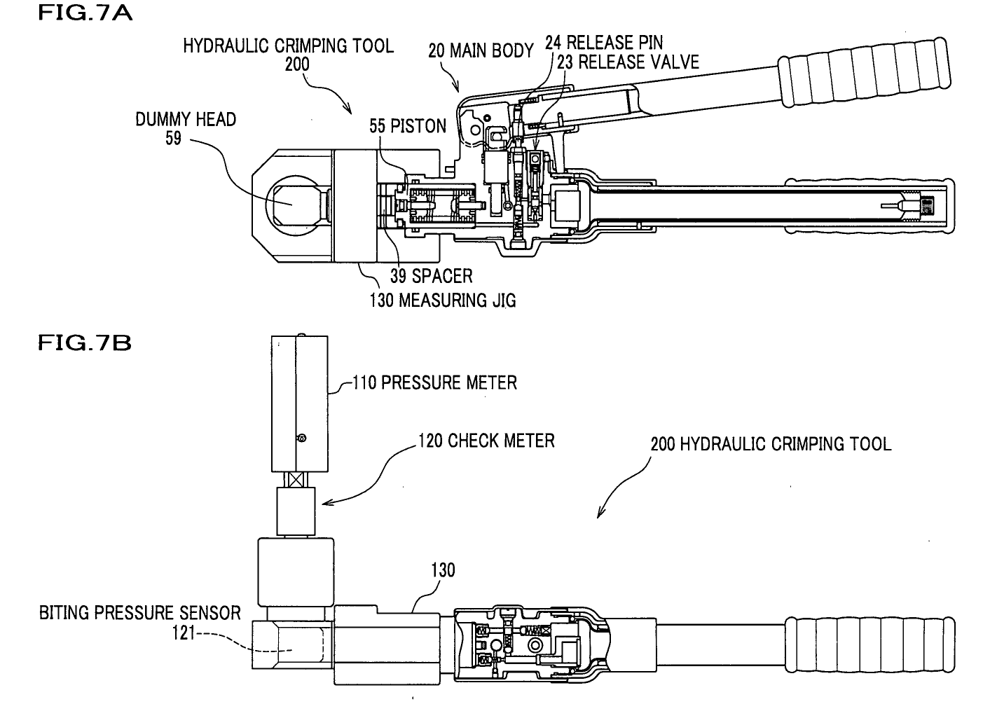

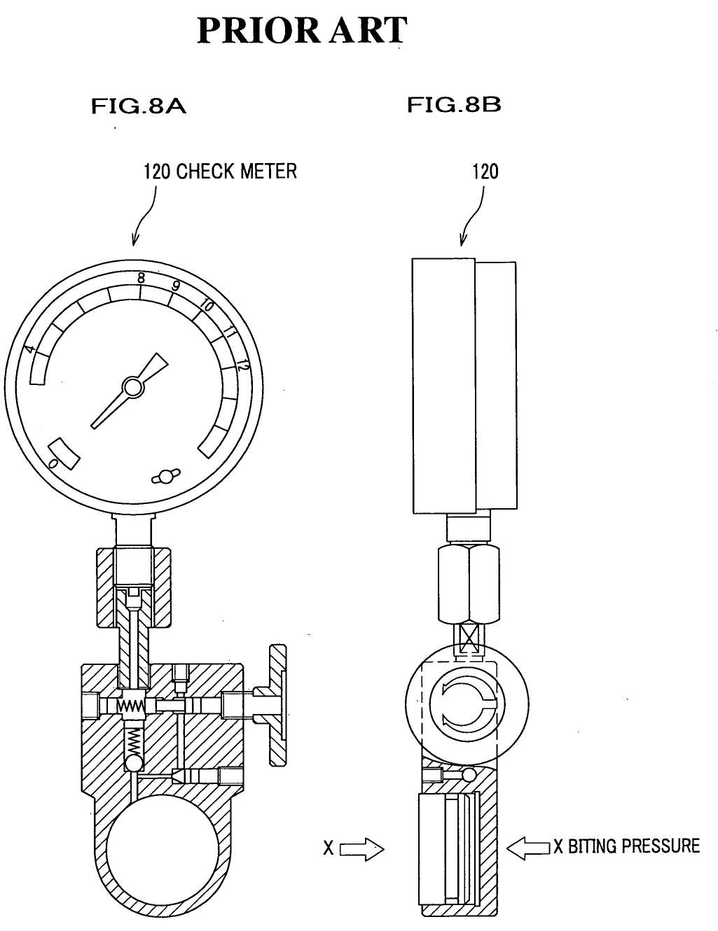

As shown in FIGS. 1A and 1B, a check meter 100 includes a biting pressure sensor 1 and a Bourdon tube pressure meter 10 which are both coupled to each other through a duct, etc. The biting pressure sensor 1 includes a cylinder 2, and a piston 3 which is hermetically fitted into the cylinder 2 and which is moved into the cylinder 2 depending on a biting pressure of the hydraulic crimping tool 200 (see FIG. 7). The check meter 100 has a structure that a pressure meter 10 measures a liquid pressure of an operating oil 4 in the cylinder 2, and a needle 11 then points to the measured value on an instrument panel 12.

For a reason that will be described later, a width W of the biting pressure sensor 1 in a direction Y perpendicular to a direction X in which a biting pressure exerts the biting pressure sensor 1 is defined to be equal to/less than 26 mm.

The cylinder 2 has an end on which the biting pressure sensor 1 is formed, and the other end into which a pressure reducing piston 14 is hermetically fitted. An upper portion of the pressure reducing piston 14 is sealed by a tubular cover 22 having an upper narrow portion, which is covered by a switch joint 13. Additionally, to this switch joint 13, the pressure meter 10 is coupled.

An oil communication between the biting pressure sensor 1 and the pressure meter 10 is blocked by the pressure reducing piston 14, but a pressure is transmitted therebetween. Into grooves formed on the circumferences of individual components, O-rings and back-up rings are inserted in order to prevent leakages between the components. Concretely, the leakage between the piston 3 and the cylinder 2 is prevented by an O-ring 3b and a back-up ring 3c strung around the piston 3. Additionally, the leakage between the cylinder 2 and the pressure reducing piston 14 is prevented by an O-ring 14a and a back-up ring 14b strung around a large-diameter portion of the pressure reducing piston 14 and by an O-ring 14c and a back-up ring 14d around a small-diameter portion thereof. Moreover, the leakage between the cylinder 2 and the cover 22 is prevented by an O-ring 12a and back-up ring 12b inserted into a groove on an inner surface of the cover 22.

The operating oil 4 flows from a hydraulic chamber 7a to a hydraulic chamber 7b below the pressure reducing piston 14 through an oil path 8. Between a hydraulic chamber 7c above the pressure reducing piston 14 and a hydraulic chamber 7d, a steel ball 16 is placed. This steel ball 16 is biased by a spring 17 to thereby function as a check valve. Moreover, a handle 18 (see FIG. 1A) which is turnably screwed into a hole of the cover 22 is provided. At the deeper point of this hole, a steel ball 19 is placed so as to open/close a narrow path 18a. When the handle 18 is turned in a predetermined direction until the steel ball 19 opens the narrow path 18a, a bypass 9 is opened so that the steel ball 16 functions as a check valve.

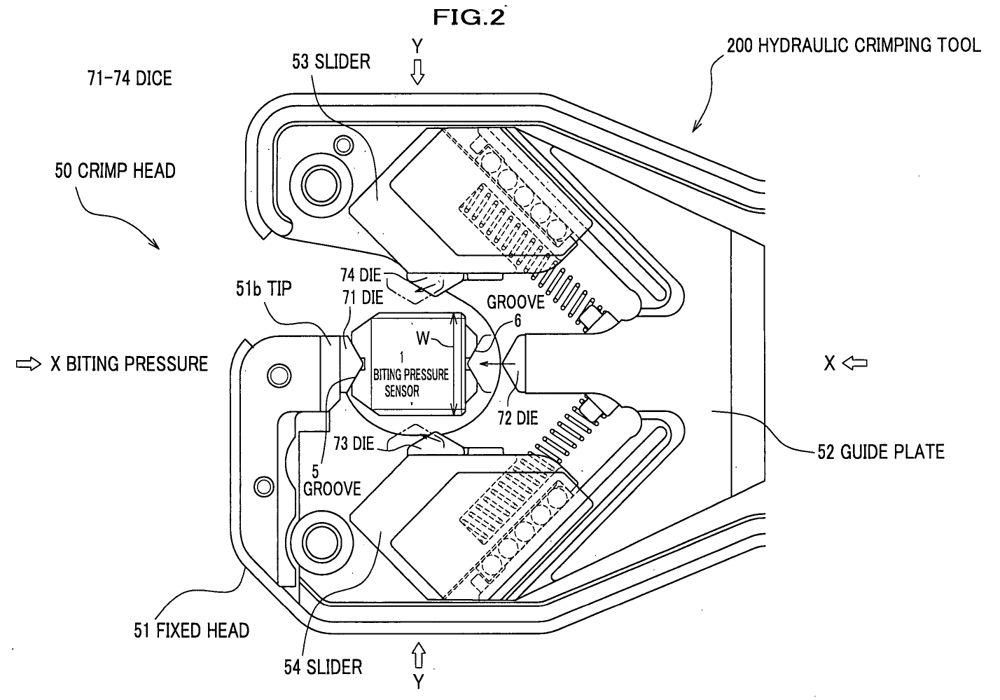

FIG. 2 is an enlarged plane view of the crimp head in which dice bite a biting pressure sensor together. With reference to FIG. 2, a description will be given of an operation in which the check meter 100 (see FIG. 1) directly measures a biting pressure of the crimp head 50. Note that the same reference numerals are given to the same parts as those already described in Description of the Related Art, and duplicate description therefore will be omitted.

The dice 72 to 74 are coupled to the piston 55 in the main body 20 (see FIG. 7) and are moved in conjunction therewith. The manual movement of the pressurized handle 40 renders the dice 72 to 74 move toward the center of the crimp head 50.

The fixed die 71 on the tip 51b of the fixed head 51 creates a biting force directing toward the center in relation to the moving dice 72 to 74. These dice bite together a biting pressure sensor 1 of the check meter 100 instead of the sleeve 46, that is, a work piece to be machined. In this case, only the opposed dice 71 and 72 out of the dice 71 to 74 bites the biting pressure sensor 1, and this biting pressure sensor 1 then creates a liquid pressure in proportion to the biting force imparted on the sensor 1 itself. Subsequently, the pressure meter 10 measures this liquid pressure of the operating oil 4. As a result, the check meter 100 determines the biting force of the hydraulic crimping tool 200.

If the biting pressure sensor 1 were deformed due to the biting force of the dice 71 and 72 as with the sleeve 46, that is, a work piece to be machined, then the biting pressure sensor 1 could not be subjected to a repetitive use, and the check meter 100 could not have a long life time as measuring equipment. Therefore, on the surfaces of the cylinder 2 and the piston 3, recesses for having surface-contact with the dice 71 and 72, or grooves for having line-contact therewith are provided. These recesses or grooves enable the biting pressure sensor 1 to receive the biting pressure exerted by the angular dice 71 and 72 without any deformation, so that the biting pressure sensor 1 can be repeatedly used.

Note that the width W of the biting pressure sensor 1 in the Y direction perpendicular to the X direction in which the biting pressure exerts the biting pressure sensor 1 is equal to/less than 34.8 mm, preferably equal to/less than 26 mm. It is because the biting pressure sensor 1 is adapted for the minimum opening length, or 34.8 mm, of the standard specifications in hydraulic crimping tools. By limiting the width W to the above length, the biting pressure is measured on the condition that the dice 73 and 74 are not abutted on the flat surfaces of the biting pressure sensor 1, and that only the dice 71 and 72 hence bite the biting pressure sensor 1 together. This results in prevention of distribution of the biting forces.

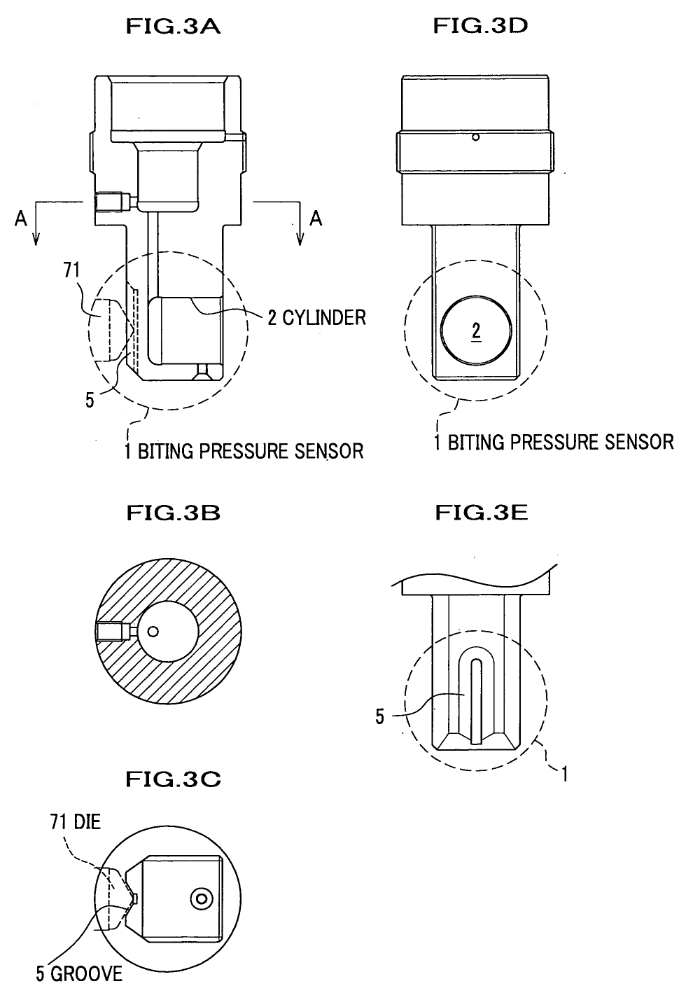

FIGS. 3A to 3E are views depicting the cylinder of the check meter according to the present invention. Specifically, FIG. 3A is a side view of the cylinder; FIG. 3B is a sectional view taken along line A-A of FIG. 3A; FIG. 3C is a bottom view thereof; FIG. 3D is a front view thereof; and FIG. 3E is a rear view thereof.

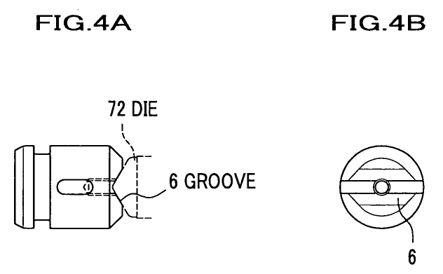

FIGS. 4A and 4B are views depicting a piston of the check meter. Specifically, FIG. 4A is a bottom view of the piston; and FIG. 4B is a front view thereof.

A cylindrical recess in the cylinder 2 shown in FIG. 3A has a piston 3 hermetically fitted thereinto (see FIG. 1). The operating oil 4 (see FIG. 1) fills a space defined by the cylinder 2 and the piston 3. The piston 3 is moved into the cylinder 2 by a depth depending on the biting pressure exerted on the biting pressure sensor 1. Accordingly, the check meter 100 is able to create the liquid pressure in proportion to the biting pressure.

A groove 5 of the cylinder 2 shown in FIGS. 3A, 3C and 3E receives the biting pressure of about 65 MPa from the angular die 71, but the surface with the groove 5 is not deformed, because the die 71 is in substantial surface or line contact with this groove 5.

Likewise, a groove 6 of the cylinder 2 shown in FIG. 4A receives the biting pressure of about 65 MPa from the angular die 72, but the surface with the groove 6 is not deformed, because the die 71 is in substantial surface or line contact with this groove 6.

Next, a procedure for measuring the biting pressure of the hydraulic crimping tool 200 with the check meter 100 and an operation regarding the interior of the check meter 100 will be described with reference to FIGS. 1 to 5 and FIG. 7 as appropriately.

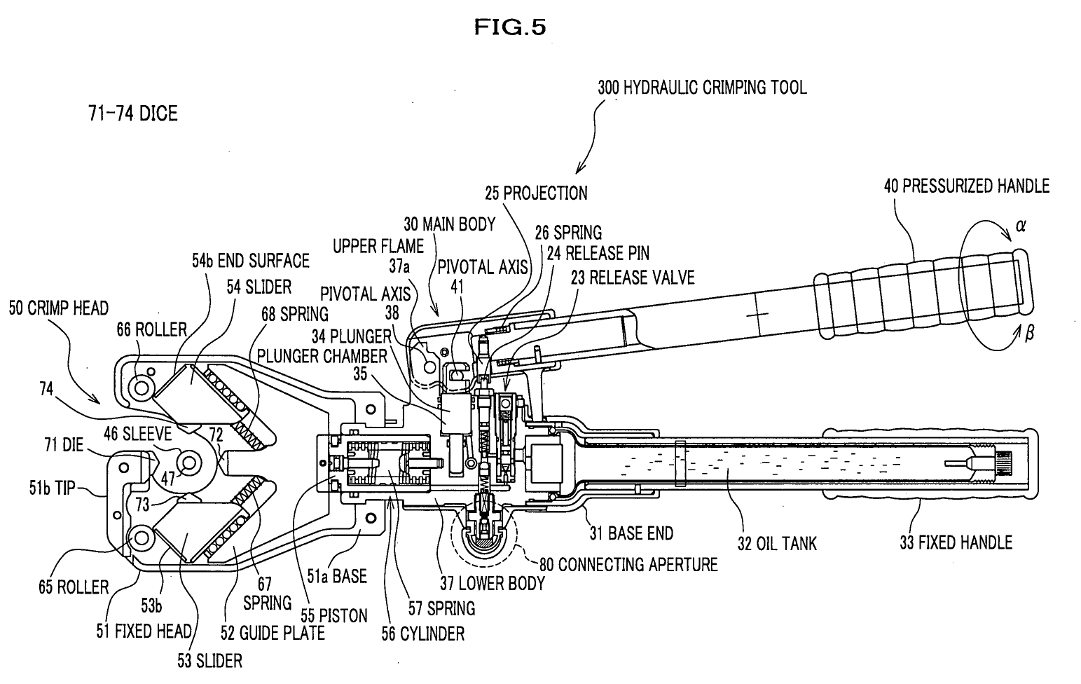

In FIG. 5, between dice 71 and 72 of the hydraulic crimping tool 300, the sleeve 46 and the electrical wire, as work pieces to be machined, are fixed.

In the hydraulic crimping tool 300, when the pressurized handle 40 is moved upwardly and downwardly, the cylinder 56 receives a liquid pressure created by a pump mechanism being constituted mainly of the plunger 34 to thereby push out the guide plate 52 and the die 72 toward the center thereof. Consequently, the biting pressure sensor 1 which is fixed between the die 72 and die 71 facing each other receives a biting pressure.

The biting pressure sensor 1 creates the liquid pressure in proportion to this biting pressure. Then, the angular die 71 pushes the groove 5 of the cylinder 2 with the biting pressure of about 65 MPa, while the angular die 72 pushes the groove 6 of the piston 3 with the same biting pressure. The dice 73 and 74 of the sliders 53 and 54, respectively, are made to approach each other to a minimum opening length of equal to/more than 34.8 mm. Accordingly, the biting pressure sensor 1 having the width W of equal to/less than 26 mm dose not undergo any interference by the dice 73 and 74.

In the hydraulic chamber 7a of the biting pressure sensor 1, the liquid pressure of the operating oil is developed to about 65 MPa equal to the biting pressure. Then, the operating oil 4 of this high pressure enters the hydraulic chamber 7b through the oil path 8, and pushes up the pressure reducing piston 14. In the pressure reducing piston 14, a ratio of the radius of the upper part to the lower part is set to be r′:r. Hence, the following relation will be given:
P/P′=(1/S)/(1/S′)=(1/πr²)/(1/πr′²)=(r′/r)²
where P designates a pressure of the lower part; P′ designates a pressure of the upper part; S designates an area of the lower part; and S′ designates an area of the upper part.

To give an example, if a ratio of the radius of the upper and lower portions is 2:1, then the ratio of the pressure is 1:4. Thus, the pressure of about 16 MPa (about 65 MPa/4 MPa) is transmitted to the hydraulic chamber 7c. Due to this pressure, the steel ball 16 which functions as a check valve between the hydraulic chambers 7c and 7d is lifted up against the urging force of the spring 17. Subsequently, the pressure of about 16 MPa is transmitted to the pressure meter 10 through the hydraulic chambers 7c and 7d. As a result, the pressure meter 10 reads 65 MPa which is a value obtained by quadrupling the 16 MPa.

Subsequently, thanks to an effect of the check valve, the needle 11 on the instrument panel of the pressure meter 10 stays as it is, and the pressure meter thus keeps reading 65 MPa. This enables a user to easily and accurately perceive the value to which the needle 11 on the instrument panel 12 points, although the check meter 100 is removed from the hydraulic crimping tool. When a user turns the handle 18 in the direction that looses it, the blockage in the narrow path 18a owing to the steel ball 19 is eliminated. Therefore, the operating oil 4 that has been trapped in the pressure meter 10 returns to the hydraulic chambers 7d and 7c through the bypass 9, and the pressure meter 10 reads 0 as shown in FIG. 1A. Then, the pressure reducing piston 14 is pushed down by means of the urging force of the spring 15, and the operating oil 4 in the hydraulic chamber 7b returns to the hydraulic chamber 7a through the oil path 8, pushing back the piston 3 in the direction that extends it from the cylinder 2. Thanks to a position restriction mechanism constituted of a guide groove 3a on the circumference of the piston 3 and a bolt 21 inserted thereinto, the piston 3 is not turned, and the orientation of the groove 6 is maintained.

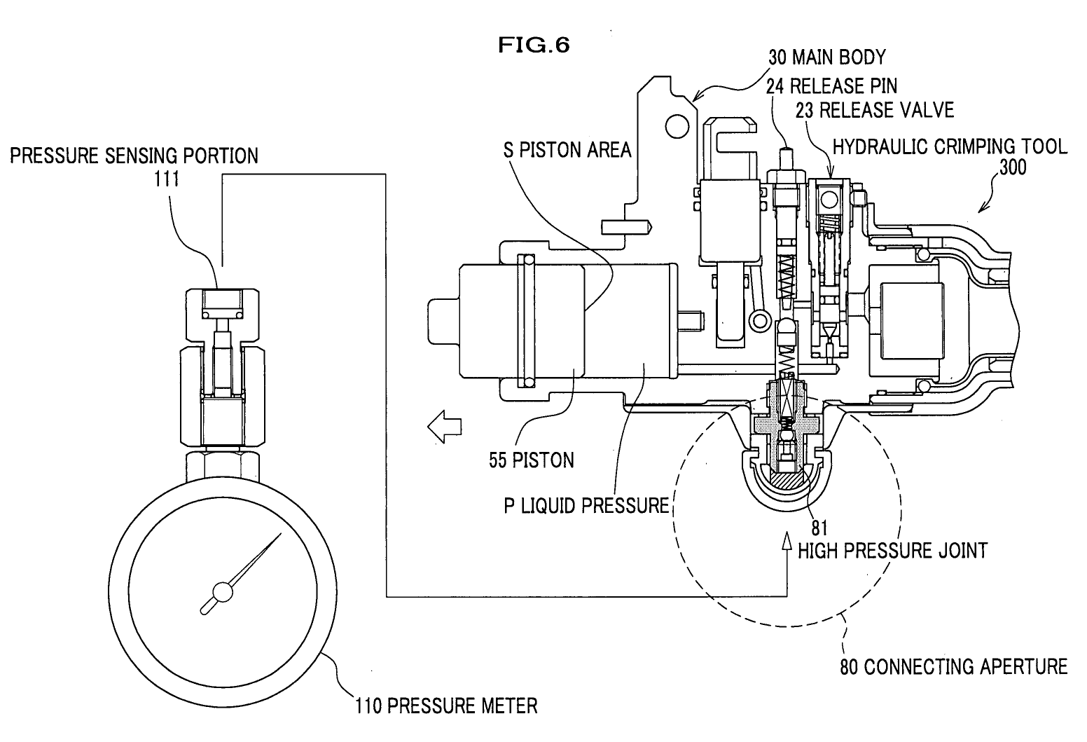

By following the above-described procedures, the measurement of the biting pressure of the hydraulic crimping tool 300 with the check meter 100 is repeated. In such a series of measuring operations, using the above check meter 100 allows the connecting aperture 80 shown in FIGS. 5 and 6 to become unnecessary, thus saving the inconvenience of attaching the pressure meter 110 to this connecting aperture 80. Further, it is possible to eliminate the possibility that air, etc. enter the hydraulic circuitry of the hydraulic crimping tool 300 upon the attachment. The measuring jig 130 shown in FIG. 7 is also unnecessary, and man-hours devoted to the attachment thereof are thus eliminated.

Note that the above description has been given, provided that an object measured with the check meter 100 is a manual hydraulic crimping tool, but this check meter 100 is not limited to such manual hydraulic crimping tools, but can be used with electric motor-driven hydraulic crimping tools.

From the aforementioned explanation, those skilled in the art ascertain the essential characteristics of the present invention and can make the various modifications and variations to the present invention to adapt it to various usages and conditions without departing from the spirit and scope of the claim.

1. A check meter for measuring a biting pressure of a hydraulic crimping tool, the hydraulic crimping tool having a plurality of angular dice which inwardly press a work piece together, the check meter comprising:
a biting pressure sensor being bitten by at least two opposed dice out of the dice, the biting pressure sensor for creating a liquid pressure in proportion to a biting pressure exerted by the two dice; and
a pressure meter capable of measuring the liquid pressure created by the biting pressure sensor.

2. A check meter according to claim 1, wherein
the biting pressure sensor comprises a cylinder and a piston that is fitted into the cylinder and that is moved into the cylinder by means of the biting pressure, and each of the cylinder and the piston has a surface being provided with one of a recess and a groove, the recess being adapted to have surface-contact with corresponding one of the two dice, the groove being adapted to have line-contact with corresponding one of the two dice.

3. A check meter according to claim 1, wherein
the biting pressure sensor has a width of at most 26 mm perpendicular to a direction in which the biting pressure exerts the biting pressure sensor.

4. A check meter according to claim 2, wherein
the biting pressure sensor has a width of at most 26 mm perpendicular to a direction in which the biting pressure exerts the biting pressure sensor.
